(19) United States
(12) Patent Application Publication
(10) Pub. No.: US 2008/0274031 A1
(43) Pub. Date: Nov. 6, 2008

(54) Method for Producing High Purity Silicon

(75) Inventors: Nobuaki Ito, Chiba (JP); Jiro Kondo, Chiba (JP); Kensuke Okazawa, Chiba (JP); Masaki Okajima, Chiba (JP)

Correspondence Address: BIRCH STEWART KOLASCH & BIRCH, PO BOX 747, FALLS CHURCH, VA, 22040-0747, US

(73) Assignee: NIPPON STEEL MATERIALS CO., LTD, TOKYO (JP)

(21) Appl. No.: 11/885,801

(22) PCT Filed: Feb. 28, 2006
(86) PCT No.: PCT/JP06/04194

§ 371 Date: May 22, 2008

(30) Foreign Application Priority Data
Mar. 7, 2005 (JP) 2005-062557

(51) Int. Cl. C01B 33/037

(52) U.S. Cl. 423/350

(57) ABSTRACT

The invention relates to a method for producing a great deal of inexpensive high purity silicon useful in a solar battery. Disclosed is a method for producing high purity silicon by removing boron from silicon by oxidization including commencing an oxidization reaction between an oxidizing agent and molten silicon, and cooling at least part of the oxidizing agent during the reaction.

This application claims priority to Japanese patent application No. 2005-062557, filed in Japan on Mar. 7, 2005, the entire contents of which are herein incorporated by reference.

### BACKGROUND OF THE INVENTION

1. Field of the Invention

The present invention relates to a method for producing high-purity silicon. The high-purity silicon is used for a solar battery.

2. Description of the Related Art

As for silicon to be used for a solar battery, the purity has to be 99.9999 mass % or more, and each of the metallic impurities in the silicon is required to be not more than 0.1 mass ppm. Especially, the impurity of boron (B) is required to be not more than 0.3 mass ppm. Although silicon made by the Siemens Process, which is used for semiconductor silicon, can meet the above requirements, the silicon is not suitable for a solar battery. This is due to the fact that the manufacturing cost of silicon made by the Siemens Process is high while a solar battery is required to be inexpensive.

Several methods have been presented in order to produce high-purity silicon at a low cost.

The process of unidirectional solidification of silicon metal has been well known for a long time. In such a process, molten silicon metal is unidirectionally solidified to form a more purified solid phase silicon utilizing the difference in solubility of impurities between solid phase and liquid phase. Such a process can be effectively used for purifying silicon from a variety of metallic impurities. However, this method cannot be used for purifying silicon from boron. This is because the difference in solubility of boron between solid phase and liquid phase is too small to purify silicon from boron.

The process of vacuum melting silicon is also well known. This process removes low boiling point impurities from silicon by holding molten silicon in a vacuum state, which is effective to remove carbon impurities from silicon. However, this method cannot be applied to purifying silicon from boron because boron in molten silicon does not normally form a low boiling point substance.

As mentioned above, boron has been thought to be a problematic component because boron in silicon is the most difficult impurity to remove and yet greatly affects the electrical properties of the silicon. Methods for which the main purpose is to remove boron from silicon are disclosed as follows.

JP56-32319A discloses a method for cleaning silicon by acid, a vacuum melting process for silicon and a unidirectional solidification process for silicon. Additionally, this reference discloses a purification method using slag for removing boron. In such a method, slag is placed on molten silicon and the impurities migrate from the silicon to the slag. In the patent reference JP56-32319A, the partition ratio of boron (concentration of boron in slag/concentration of boron in silicon) is 1.357 and the obtained concentration of boron in the purified silicon is 8 mass ppm by using slag including (CaF₂+CaO+SiO₂). However, the concentration of boron in the purified silicon does not satisfy the requirements of silicon used for solar batteries. The disclosed slag purification cannot industrially improve the purification of silicon from boron because the commercially available raw material for the slag used in this method always contains boron on the order of several mass ppm (ppm by mass). Thus, the purified silicon inevitably contains the same level of boron concentration as in the slag unless the partition ratio is sufficiently high. Consequently, the boron concentration in the purified silicon obtained by the slag purification method is at best about 1.0 mass ppm when the partition ratio of boron is 1.0 or so. Although it is theoretically possible to reduce the boron concentration by purifying the raw slag materials, this is not industrially feasible because it is economically unreasonable.

JP58-130114A discloses a slag purification method, where a mixture of ground crude silicon and slag containing alkaline-earth metal oxides and/or alkali metal oxides are melted together. However, the minimum boron concentration of the obtained silicon is 1 mass ppm, which is not suitable for a solar battery. In addition, it is inevitable that new impurities are added when the silicon is ground, which also makes this method inapplicable to solar batteries.

JP2003-12317A discloses another purification method. In this method, fluxes such as CaO, CaO₃ and Na₂O are added to silicon and they are mixed and melted. Then, the blowing of oxidizing gas into the molten silicon results in purification. However, silicon purified by this method has a boron concentration of about 7.6 mass ppm, which is not suitable for use in a solar battery. Furthermore, it is difficult, from an engineering point of view, to blow stable oxidizing gas into molten silicon at a low cost. Therefore, the method disclosed in JP2003-12317A is not suitable for the purification of silicon.

Non-patent reference, “Shigen to Sozai” (Resource and Material) 2002, vol. 118, p. 497-505, discloses another example of slag purification where the slag includes (Na₂O+CaO+SiO₂) and the maximum partition ratio of boron is 3.5. The partition ratio 3.5 is the highest value disclosed in the past, however, this slag purification is still inapplicable to solar batteries considering the fact that the boron concentration in practically available raw slag material.

As mentioned above, the slag purification method is generally an easy and inexpensive way to purify silicon since it simply involves placing slag on molten silicon. However, the obtained silicon is not suitable for use in a solar battery because slag purification fails to obtain a practically available high partition ratio of boron.

Boron removal techniques other than slag purification have also been proposed. Such techniques include various purification methods where boron is removed from silicon by vaporization after being oxidized.

JP04-130009A discloses a boron removal method where boron in silicon is removed by blowing plasma gas with gases such as water vapor, O₂ and/or CO₂ and oxygen-containing materials such as CaO and/or SiO₂ into the molten silicon.

JP04-228414A discloses a boron removal method where boron in silicon is removed by blowing a plasma jet with water vapor and SiO₂ into the molten silicon.

JP05-246706A discloses a boron removal method where boron in silicon is removed by blowing an inert gas or an oxidizing gas into the molten silicon while keeping an arc between the molten silicon and an electrode located above the surface of the molten silicon.

U.S. Pat. No. 5,972,107 and U.S. Pat. No. 6,368,403 disclose methods for purifying silicon from boron where a special torch is used and water vapor and SiO₂ are supplied in addition to oxygen and hydrogen and CaO, BaO and/or CaF₂ to molten silicon.

JP04-193706A discloses a boron removal method where boron in silicon is removed by blowing gas such as argon gas and/or H₂ gas into the molten silicon from a bottom inlet.

JP09-202611A discloses a boron removal method where boron in silicon is removed by blowing a gas including Ca(OH)₂, CaCO₃ and/or MgCO₃ into molten silicon.

Some techniques disclosed in the above mentioned references from JP04-130009A to JP09-202611A can remove boron from silicon to the extent that the boron concentration in the silicon meets the requirements for use in a solar battery. All of these the techniques, however, use a plasma device and/or gas blowing apparatus which are expensive and require complicated operation. This makes it difficult to adopt these techniques as practical techniques from the viewpoint of economic efficiency.

### SUMMARY OF THE INVENTION

An object of the present invention is to provide a method of producing high purity silicon in a simple manner and at low cost, by purifying crude silicon from impurities, particularly boron, to a level useful for solar batteries.

The present inventors have designed the following solutions after studying silicon production.

One embodiment of the present invention relates to a method for producing high purity silicon by removing boron from silicon by oxidization thereof comprising commencing an oxidization reaction between an oxidizing agent and molten silicon, and cooling at least a part of the oxidizing agent during the oxidation reaction. This method can further include blowing a cooling gas onto the oxidizing agent.

In another embodiment, the oxidizing agent is placed so as to directly contact the molten silicon. This method can further include the step of blowing a cooling gas onto the oxidizing agent.

In another embodiment, the method further comprises placing a cooling material on the oxidizing agent, wherein the cooling material has a temperature lower than that of the molten silicon. This method can further include blowing a cooling gas onto the oxidizing agent and/or the cooling material.

In one embodiment of the present invention, the cooling material comprises as a primary component at least one of the following materials: silica, alumina, magnesia, zirconia and calcia.

In an alternate embodiment, the cooling step is conducted by blowing a cooling gas on at least a part of the oxidizing agent, wherein the cooling gas has a temperature lower than that of the oxidizing agent.

A further embodiment of the present invention relates to a method for producing high purity silicon by removing boron from silicon by oxidization thereof, comprising placing an insulation material on molten silicon, placing an oxidizing agent on the insulation material, and commencing an oxidization reaction between the oxidizing agent and the molten silicon.

In another aspect of the invention, the method further comprises blowing a cooling gas onto the oxidizing agent and/or the insulation material. The insulation material may comprise a porous material having an average temperature lower than that of the molten silicon. Further, the oxidizing agent may be arranged over the porous material and/or inside the porous material so that temperature increase of the oxidizing agent can be restrained. Additionally, the insulation material may comprise as a primary component at least one of the following materials: silica, alumina, magnesia, zirconia and calcia.

In another embodiment, the oxidizing agent is a material comprising as a primary component at least one of the following: alkali metal carbonate, hydrate of alkali metal carbonate, alkali metal hydroxide, alkaline-earth metal carbonate, hydrate of alkaline-earth metal carbonate and alkaline-earth metal hydroxide.

In yet another embodiment, the oxidizing agent is a material comprising as a primary component at least one of the following: sodium carbonate, potassium carbonate, sodium hydrogen carbonate, potassium hydrogen carbonate, magnesium carbonate, calcium carbonate, hydrates of each of the above carbonates, magnesium hydrate and calcium hydrate.

The method of the present invention is able to reduce the boron concentration in silicon to 0.3 mass ppm or less without using expensive equipment such as a plasma device or a gas-blowing device. The silicon obtained according to the present method is of a purity useful in solar batteries. Further, the combined use of the present invention and conventional unidirectional solidification processes or conventional vacuum melting processes can supply silicon available as a raw material for a solar battery with high quality and low cost.

### BRIEF DESCRIPTION OF THE DRAWINGS

FIG. 1 is a schematic diagram illustrating one embodiment of the present invention where an insulating material is used.

FIG. 2 is a schematic diagram illustrating another embodiment of the present invention where the oxidizing agent directly contacts the molten silicon and a cooling material is used to cool a part of the oxidizing agent.

FIG. 3 is a schematic diagram illustrating another embodiment of the present invention where a cooling gas is used.

FIG. 4 is a schematic diagram of another aspect of the present invention where a cooling plate is employed.

FIG. 5 is a schematic diagram illustrating another aspect of the present invention where the crucible provides a cooling function.

### PREFERRED EMBODIMENTS OF THE INVENTION

The conventional technologies mentioned above can be classified into four categories. The first category includes methods where slag only is supplied onto molten silicon (disclosed in JP56-32319A and JP58-130114A, hereinafter referred to as “simple slag purification method”). The second category includes methods where an oxidizing gas is contacted with molten silicon (disclosed in JP04-228414A and JP05-246706A, hereinafter referred to as “gas oxidization method”). The third category includes methods where a solid oxidizing agent (e.g., MgCO₃) is blown into the molten silicon with a carrier gas (disclosed in JP09-202611, hereinafter referred to as “oxidizing agent blowing method”). The fourth category includes methods where in addition to contacting oxidizing gas with the molten silicon, slag and/or raw slag materials such as SiO₂, are also supplied to the molten silicon (disclosed in JP2003-12317A, JP04-130009A, U.S. Pat. No. 5,972,107, U.S. Pat. No. 6,368,403 and JP04-193706A, hereinafter referred to as “complex slag purification method”). Compared to this, the present invention contacts an oxidizing agent with molten silicon without the use of a special carrier gas. At the same time, the present invention is conducted so as to restrain temperature increase in the oxidizing agent. The present method does not belong to any of the above categories of conventional technology.

A principle of the present invention is described below. As shown in the “gas oxidization method” and the “oxidizing agent blowing method” mentioned above, boron can be effectively removed from the silicon by being oxidized. Therefore, if boron in molten silicon could be effectively oxidized by simply placing an oxidizing agent in solid or liquid state on the molten silicon, an inexpensive boron removal method would be realized. In fact, such a method has not been realized because a generally used oxidizing agent is easily turned into gas by decomposing and vaporizing at temperatures above the melting point of silicon. Even if the oxidizing agent is fed at room temperature, most of the oxidizing agent is finally vaporized after staying on the molten silicon and being heated for long time. This results in the feeding of large amounts of oxidizing agent as well as the processing of an enormous amount of exhaust gas. This costs a great deal. Further, in some situations, direct contact between the molten silicon and the oxidizing agent can cause an explosive generation of gas from the oxidizing agent. This can cause the molten silicon to splash up and/or damage the apparatus. In view of this, for boron removal involved in the purification of silicon using an oxidizing agent, there has been no choice but to implement a method where the oxidizing agent contacts the molten silicon only for a short period of time. The “oxidizing agent blowing method” mentioned above is an example of a method where boron oxidization can be conducted in a short-time period. This method involves a finely powdered oxidizing agent with a large specific surface being fed into the molten silicon using a carrier gas. This provides a large reaction area per unit mass of oxidizing agent. As mentioned before, however, the “oxidizing agent blowing method” requires a gas blowing apparatus and extremely fine-powdered oxidizing agent. This results in an expensive manufacturing facility and requires complicated operation. Thus, the “oxidizing agent blowing method” is not regarded as effective way to remove boron from silicon. If there were a suitable oxidizing agent that could stay in solid or liquid state at high temperatures, it would not be necessary to blow the oxidizing agent into the molten silicon. However, there has been no oxidizing agent found which is stable at high temperatures, inexpensive, has a high ability to oxidize boron, and has a low possibility of contaminating the silicon. For example, both barium carbonate and barium oxide have the ability to oxidize boron and are not vaporized at the melting point temperature of silicon. However, such oxidizing agents that do not decompose at high temperatures are basically stable materials. Therefore, the reaction rate between boron in the silicon and barium carbonate or barium oxide is slow. This leads to a very low productivity of purification.

In the present invention, the oxidizing agent on the molten silicon can be kept stable for a long time by cooling the oxidizing agent and/or thermally insulating the oxidizing agent from the ambient atmosphere. Therefore, temperature increase of the oxidizing agent is limited to the area adjacent to the molten silicon, and the oxidizing agent in other areas is kept at a lower temperature. This restrains the vaporization of the oxidizing agent.

In the present invention, it is also possible to increase the oxidation rate of the boron in the silicon. It has been known that when a large amount of oxidizing agent directly contacts molten silicon, the oxidization rate of the boron in the silicon increases greatly. However, as a manner of contact, if an oxidizing agent is simply placed on the molten silicon, gas from the oxidizing agent is explosively generated and stops the operation as described above. Therefore, this method has not come into practical use. In the present invention, however, since the oxidizing agent is cooled, temperature increase of most of the oxidizing agent that is not in the area adjacent to the molten silicon can be restrained. Therefore, explosive gas generation can be avoided even if the oxidizing agent directly contacts the molten silicon. This allows a large amount of oxidizing agent to directly contact the molten silicon in a stable condition. The cooling of the oxidizing agent does not impair the high oxidization rate of boron at the interface between the oxidizing agent and the molten silicon. The present inventors are the first to discover the phenomenon of cooling the oxidizing agent.

Construction of apparatus: An apparatus construction is described below based on FIG. 2. A crucible 2, placed in a purification furnace 1, is heated by a heater 3. Molten silicon 4 is accommodated in the crucible 2 and maintained at a certain temperature. An oxidizing agent 5 is fed through an oxidizing agent feeding tube 7 and a cooling material 6 is fed through a cooling material feeding tube 8 onto the molten silicon 4 in the crucible 2. Reaction and purification including boron removal is commenced between the molten silicon and the oxidizing agent. Contact with the cooling material cools an upper portion of the oxidizing agent layer. Thus, increase of the average temperature of the oxidizing agent is restrained so that vaporization of the oxidizing agent can be prevented. During heating and purification, the atmosphere inside the furnace is controlled with respect to the kinds and concentration of gas through a gas feeding line 10 and gas exhaust line 11. When the oxidizing agent is consumed (by reaction with the molten silicon), the cooling material and the oxidizing agent remaining on the molten silicon are discharged from the crucible by tilting the crucible using a crucible-tilting device 12 into a residue receiver 9. Then, the crucible is set to the original position and, if necessary, cooling material and oxidizing agent are again fed onto the molten silicon and the purification process is repeated.

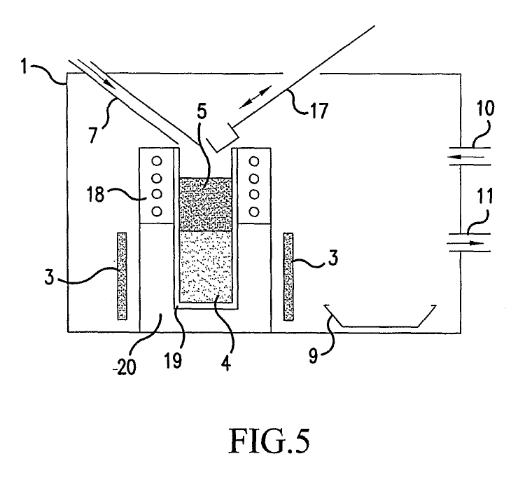

Cooling of the oxidizing agent can be conducted by contact with the inner wall of a cooled crucible. One embodiment of this is illustrated in FIG. 5 and will be further discussed below. If the oxidizing agent is one that is not vaporized until a temperature of 1000° C., the oxidizing agent can also be cooled by radiation from the surface of the oxidizing agent toward a cooling plate set above the oxidizing agent. One embodiment of this is illustrated in FIG. 4 and will be further discussed below.

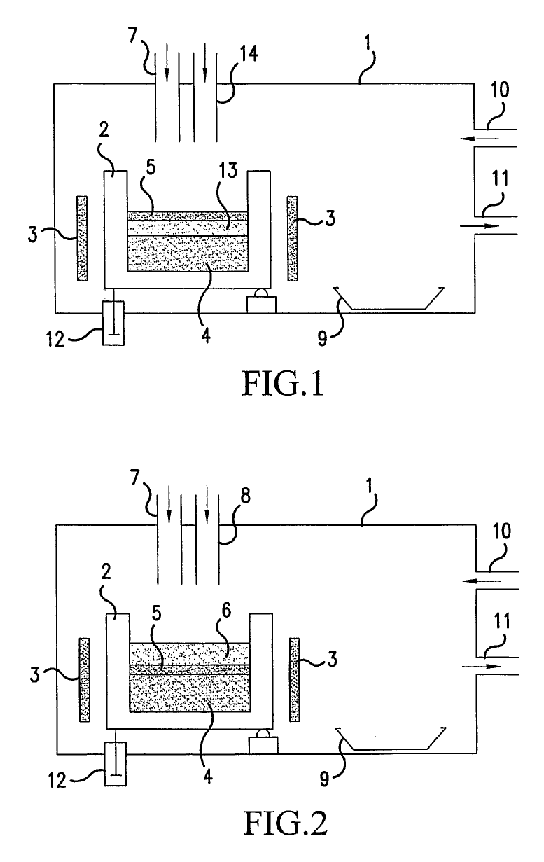

Another apparatus construction is described below based on FIG. 1. The construction and the operation procedure are the same as described for FIG. 2 except that a thermal insulation material 13 is used instead of a cooling material 6. The thermal insulation material 13 is fed through a thermal insulation material feeding tube 14 onto the molten silicon and the oxidizing agent 5 is arranged on the thermal insulation material 13. The oxidizing agent on the insulation material is arranged so as to not directly receive heat from the heater 3 in the furnace. The oxidizing agent is heated from the crucible and via the porous insulation material from the molten silicon. The portion of oxidizing agent which reaches the temperature of the melting point of silicon is fed little by little onto the molten silicon through the porous insulation material. The amount of oxidizing agent fed onto the molten silicon is small, so most of the oxidizing agent is quickly consumed for oxidizing boron. Temperature increase of the oxidizing agent located on the insulation material can be restrained because of the insulation material. This makes it possible for the oxidizing agent to remain in a stable condition for a long time without being vaporized.

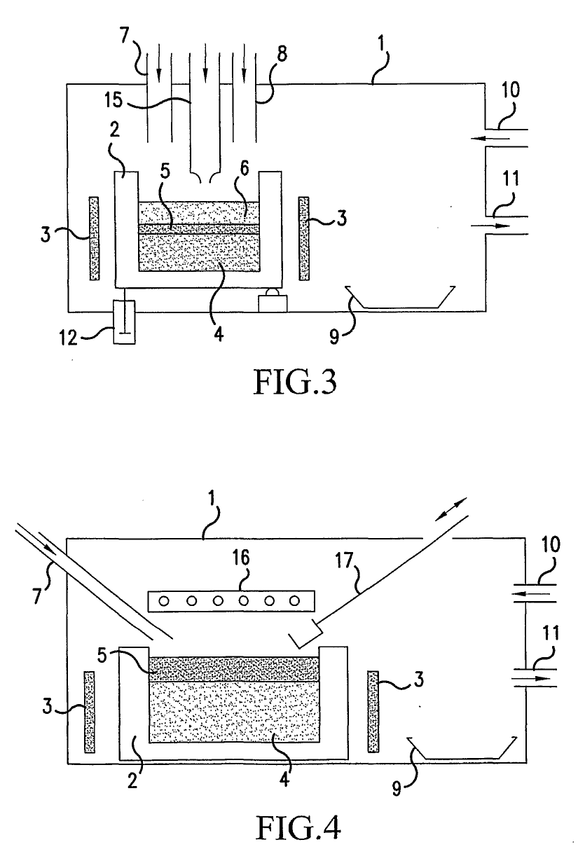

Another apparatus construction is described below based on FIG. 3. The apparatus of FIG. 3 is similar to the apparatus of FIG. 2 except it further includes a gas cooling apparatus 15. The gas cooling apparatus, including a cooled gas storage tank (not shown) and blower (not shown), blows cooling gas onto the cooling material and/or the oxidizing agent located above the molten silicon. The cooling gas is finally exhausted outside the furnace through the gas exhaust line.

Oxidizing agent: As for oxidizing agents, any oxidizing agents can be used as long as they meet the conditions of oxidizing ability, purity, ease of handling and price. Preferably, however, the oxidizing agent is a material comprising as a primary component at least one of the following materials: alkali metal carbonate, hydrate of alkali metal carbonate, alkali metal hydroxide, alkaline-earth metal carbonate, hydrate of alkaline-earth metal carbonate or alkaline-earth metal hydroxide. There are several reasons why these materials are preferred. First, they have a large oxidizing ability. Second, they contribute very little to contamination of the silicon by dissolving in the silicon. More preferably, the oxidizing agent is a material comprising as a primary component at least one of the following materials: sodium carbonate, potassium carbonate, sodium hydrogen carbonate, potassium hydrogen carbonate, magnesium carbonate, calcium carbonate, hydrates of each of the above carbonates, magnesium hydrate or calcium hydrate. There are several reasons why these materials are preferred. First, these materials have the ability to form a SiO₂ film on the surface of the molten silicon, which inhibits contact between the molten silicon and the oxidizing agent, to form a low viscosity slag which is removable. Second, these materials are mass-produced goods and high purity products are surely obtained. The alkaline-earth metals mentioned include beryllium and magnesium.

Cooling material: The cooling material preferably has a large heat capacity, is stable in solid or liquid at temperatures above the gasification temperature of the oxidizing agent, and has a low possibility of contaminating the silicon. As examples of such materials, the present inventors have found that silica, alumina, magnesia, zirconia or calcia, which are preferably highly pure, can be used. Some of these materials may be converted into liquid (slag) by reacting with the oxidizing agent at temperatures higher than the melting point of silicon. However, as long as the oxidizing agent used has a low possibility of contaminating the silicon, the formation of such slag has little influence on the silicon regarding contamination. This is since slag based on silica or alumina has extremely low solubility in silicon. Also, even if a slag is formed, it is not a serious problem as long as the average temperature of the cooling material is kept sufficiently lower than the melting point of silicon. This is because the temperature increase restraining effect on the oxidizing agent still remains. The temperature of the cooling material to be fed is preferably kept low, preferably room temperature, in order to improve the heat transfer between the cooling material and the oxidizing agent and to restrain conversion of the cooling material into slag. As a shape for the cooling material to be fed, grain shape and/or lump shape can be used or an integrally molded material can be placed on the silicon. In the case of using a grain shaped or a lump shaped cooling material, the shape is preferably a spherical form from the viewpoint of increasing heat transfer so that a high filling rate can be obtained, and is preferably a plate or rod form from the viewpoint of achieving a smooth flow of oxidizing agent through the filled cooling materials. The selection of the shape of the cooling material may be determined based on parameters such as the required amount of heat removal, the required flow rate of oxidizing agent through the cooling material, whether the material is easy to obtain, and the specific conditions of the manufacturing apparatus. As for the volume of the cooling material, a larger volume of cooling material is preferable from the viewpoint of heat transfer. The preferable lower limit to the volume is 0.5 cm³. Preferably, a volume of 50 cm³ or more is used. Large sized integrally molded forms of cooling material can also be used. In the case of using a plate shape, the maximum length of the plate shape is preferably equal to the inner diameter of the crucible or less. In the case of using a lump shape, the volume is preferably 3000 cm³ or less.

Thermal insulation material: The thermal insulation material is preferably a porous material, has low heat conductivity, is stable in solid or liquid form at temperatures above the melting point of silicon, and has a low possibility of contaminating the silicon. As examples of such materials, the present inventors have found that one or more of silica, alumina, magnesia, zirconia or calcia, which are preferably highly pure, can be used. As described above with respect to the cooling material, these materials can still be changed to form a slag at high temperatures. However, a slag based on these materials has a low possibility of contaminating silicon and a low heat conductivity, i.e., high thermal insulation, which does not produce problems in use. However, if all insulation material is converted into a slag, this can cause problems since the flow paths for the oxidizing agent on the insulation material are lost. Therefore, it is necessary to predetermine the amount of oxidizing agent to be fed so that the oxidizing agent can be completely consumed before all of the insulation material turns to slag. As a shape of the insulation material to be fed, integrally molded porous insulation material can be placed so as to cover the molten silicon or grained insulation material can be placed on the molten silicon. In the case of using grained insulation material, gaps between the grained materials function as flow paths for melted oxidizing agent to flow through. Pores in the integrally molded porous insulation material provide similar function. A porous material, represents not only an integral molding material but also stacked grained materials, which have a large number of flow paths inside the stack. When the purification process of silicon is repeatedly performed, use of grained insulation material is better than use of an integrally molded insulation material in terms of discharging the insulation material. The temperature of the thermal insulation material to be fed is preferably low, preferably room temperature. As for the size of grained material, as the diameter decreases, the insulation performance increases, but flow of melted oxidizing agent through the insulation material becomes difficult. Preferably, the size ranges from 1 to 100 mm. The filling rate of grained material ranges preferably from 20 to 70% considering the smoothness of flow of melted oxidizing agent and the maintenance of shape of the grained material. For the conditions above, the shape of the grained material is preferably close to spherical. Use of a mixture of different sized grained material to increase the filling rate, for example up to 80% or more, is preferably avoided. Gaps for flow between the grained materials at preferable filling rates will preferably range from 10% to 50% of the average grained material size.

Cooling gas: As for a cooling gas, inert gas is preferable in order to prevent the crucible and/or the refractory lining from being oxidized. If the high temperature portion is limited to the molten silicon and the vicinity by heating the silicon using induction heating, and, for example, the temperature of outer surface of the crucible and the refractory lining are as low as 500° C. or less, oxidization of the crucible and the refractory lining can be ignored. Therefore, air can be used as cooling gas from an economical point of view. Although lower temperature gas works more effectively as a cooling gas, if room temperature gas is difficult to use because of recycling of the cooling gas, a relatively high temperature gas can be used as long as the temperature still has a cooling function. Generally for cooling, however, the cooling gas temperature is preferably lower, at least by 100° C., than the temperature of the surface (where the cooling gas hits) of the oxidizing agent.

Other operation condition: As for the crucible to be used, stability against the molten silicon and the oxidizing agent is desired. For example, graphite and/or alumina can be used.

As for the operation temperature, operation at too high a temperature is preferably avoided as much as possible in view of durability and contamination of the refractory lining. The temperature of the molten silicon is preferably between the melting point of silicon and 2000° C. The temperature of the silicon obviously has to be at the temperature of the melting point of silicon or higher.

As for the atmosphere of operation, a reducing atmosphere such as hydrogen gas is preferably avoided so as not to inhibit the oxidization of boron in the molten silicon. In the case where graphite is used as the crucible and/or the refractory lining, an oxidizing atmosphere such as air is preferably avoided in order to avoid the deterioration of the crucible and/or the refractory lining by oxidization. Therefore, an inert gas atmosphere such as an argon gas atmosphere is preferred. When the temperature of the graphite is kept low, so that deterioration of the graphite by oxidization is relatively small, and so long as economic loss from the deterioration is smaller than the expense of the inert gas, then an atmosphere composed of air may be used. As for the ambient pressure there is no special limitation. However, low pressures such as 100 Pa or less may cause vaporization of the oxidizing agent, which may unnecessarily increase the consumption of oxidizing agent. Therefore, normally the pressure is preferably more than 100 Pa.

### EXAMPLES

### Example 1

Silicon purification is carried out using a purification furnace as shown in FIG. 2. 50 kg of metal silicon grain having a boron concentration of 12 mass ppm and an average diameter of 5 mm is accommodated in a graphite crucible having a diameter of 500 mm and placed in the purification furnace. The crucible is heated by a resistance heater to 1500° C. in an argon atmosphere and the molten silicon is maintained at 1500° C. Then, 15 kg of powdered sodium carbonate (Na₂CO₃) having a boron concentration of 0.3 mass ppm and a temperature of room temperature, is fed onto the molten silicon in the purification furnace through the oxidizing agent feeding tube. After flattening the surface of the oxidizing agent so that the depth of the oxidizing agent on the molten silicon becomes uniform, 100 kg of a high purity silica cooling material having a boron concentration of 1.5 mass ppm, an average diameter of 60 mm, and a temperature of room temperature, is fed onto the molten silicon in the purification furnace through the cooling material feeding tube. Then, the surface of the cooling material on the oxidizing agent is flattened. The time interval from feeding the oxidizing agent to feeding the cooling material is about 5 minutes. After feeding the cooling material, the silicon purification process is carried out for 20 minutes while keeping the molten silicon at 1500° C. under argon atmospheric pressure. The reaction is monitored so that the majority of the cooling material keeps its initial shape as it is fed, although some portion turns to slag. A representative temperature of the cooling material during the purification process is about 800° C. After finishing the purification, the crucible is tilted to discharge the cooling material and residue of oxidizing agent into the residue receiver and the molten silicon is sampled. The sampling is made as follows. One end of a high purity alumina tube, which is heated to a temperature greater than the melting point of silicon, is dipped into the molten silicon, and the molten silicon is sucked through the tube. Solidified silicon formed by quenching at a non-heated portion of the tube is carried out of the furnace and the solidified silicon is separated from the alumina tube as a sample to be analyzed. The weight of the sample is about 100 g. The method of component analysis of the sample is Inductively Coupled Plasma (ICP) analysis, a method that is widely used in the industry. Then, oxidizing agent and cooling material are again fed onto the molten silicon to repeat the purification. A total of five purifications are carried out. Sampling is conducted at each purification and the boron concentration in each sample has ⅓ of the concentration of the previous sample from the first to the fourth purification. The boron concentration of the finally obtained sample is 0.1 mass ppm, which satisfies the boron concentration requirements of silicon intended for solar batteries.

### Example 2

Silicon purification is carried out using a purification furnace as shown in FIG. 1. 50 kg of metal silicon grain having a boron concentration of 12 mass ppm and an average diameter of 5 mm is accommodated in a graphite crucible having a diameter of 500 mm and placed in the purification furnace. The crucible is heated by a resistance heater to 1500° C. in an argon atmosphere and the molten silicon is maintained at 1500° C. Then, 30 kg of a high purity porous aluminum thermal insulation material having a boron concentration of 1.5 mass ppm, an average diameter of 50 mm and a temperature of room temperature, is fed onto the molten silicon in the purification furnace through the insulation material feeding tube. The surface of the insulation material on the molten silicon is flattened so that the depth of the insulation material on the molten silicon is uniform. Then, 10 kg of powdered sodium carbonate (Na₂CO₃) having a boron concentration of 0.3 mass ppm and a temperature of room temperature is fed onto the insulation material in the purification furnace through the oxidizing agent feeding tube. The surface of the oxidizing agent is flattened so that the depth of the oxidizing agent on the insulation material is uniform. After feeding the oxidizing agent, the silicon purification process is carried out for 20 minutes while keeping the molten silicon at 1500° C. under argon atmospheric pressure. The reaction is monitored to make sure that the majority of the insulation material keeps its initial shape as it is fed, although some portion turns to slag. The reaction is also monitored to make sure that the oxidizing agent stays on the insulation material until the final stage of the purification and is melted little by little to infiltrate into the insulation material. After finishing the purification, the crucible is tilted to discharge the insulation material and the residue of the oxidizing agent into the residue receiver and the molten silicon is sampled in the same manner as in Example 1. Then, oxidizing agent and insulation material are again fed onto the molten silicon to repeat the purification. A total of five purifications are carried out. Sampling is made at every purification and the boron concentration in each sample has ⅓ of the concentration of the previous sample. The boron concentration of the finally obtained sample is 0.1 mass ppm, which satisfies the boron concentration requirements of silicon intended for solar batteries.

### Example 3

Silicon purification is carried out using a purification furnace as shown in FIG. 3. After making preparation similar to Example 1, molten silicon, oxidizing agent and cooling material are arranged and kept at 1500° C. under argon atmospheric pressure. The cooling material is cooled by blowing argon gas at room temperature through a gas cooling apparatus onto the cooling material at a flow rate of 10 m³/min. While maintaining these conditions, the purification is carried out for 20 minutes. After finishing the purification, the crucible is tilted to discharge the insulation material and oxidizing agent residue into the residue receiver and the molten silicon is sampled in the same manner as in Example 1. Then, oxidizing agent and insulation material are again fed onto the molten silicon to repeat the purification. A total of five purifications are carried out. Sampling is made at every purification and the boron concentration in each sample is ⅓ of the concentration of the previous sample. The boron concentration of the finally obtained sample is 0.07 mass ppm, which satisfies the boron concentration requirements of silicon intended for solar batteries.

### Example 4

Silicon purification is carried out using a purification furnace as shown in FIG. 4. 20 kg of molten silicon (prepared in advance in another furnace) having a boron concentration of 12 mass ppm is accommodated in an alumina brick crucible having a diameter of 500 mm and placed in the purification furnace. The molten silicon 4 is heated by the induction heater 3 in an argon atmosphere and maintained at 1500° C. Then, 15 kg of powdered sodium carbonate (Na₂CO₃) having a boron concentration of 0.3 mass ppm and a temperature of room temperature is fed onto the molten silicon in the purification furnace through the oxidizing agent feeding tube 7. The surface of the oxidizing agent is flattened so that the depth of the oxidizing agent on the molten silicon is uniform. The silicon purification process is carried out for 20 minutes while keeping the molten silicon at 1500° C. under argon atmospheric pressure. During the purification, the surface of the sodium carbonate is cooled by radiation by operating a steel cooling plate 16. The steel cooling plate 16 is welded to a water cooling tube arranged so as to face the surface of the sodium carbonate and the temperature of the surface of the sodium carbonate is kept at 800° C. After finishing the purification, the residue remaining on the molten silicon is picked up by operating an alumina-made ladle-type oxidizing agent removal device 17 and discharged into the residue receiver 9. A part of the residue is cut off as a sample after being solidified and composition analysis is performed by Electron Probe MicroAnalyzer (EPMA) method and ICP method. As a result, it is found that the residue is a compound including remaining oxidizing agent, silicon oxide and a Si—Na compound. After completely removing all of the residue on the silicon, a portion of the molten silicon is sampled in the same manner as in Example 1. Then, oxidizing agent is again fed onto the molten silicon to repeat the purification. A total of five purifications are carried out. Sampling of the silicon is made at every purification by using the oxidizing agent removal device 17 and the boron concentration in each sample has ⅓ of the concentration of the previous sample. The boron concentration of the finally obtained silicon sample is 0.1 mass ppm, which satisfies the boron concentration requirements of silicon intended for solar batteries.

### Example 5

Silicon purification is carried out using a purification furnace as shown in FIG. 5. 5 kg of molten silicon (prepared in advance in another furnace) having a boron concentration of 12 mass ppm is accommodated in a crucible having a diameter of 100 mm and placed in the purification furnace. The molten silicon is heated by an induction heater 3 in an argon atmosphere and maintained at 1500° C. The crucible is constructed of 3 parts, which are a bottom part 20, a cooling part 18 and a coating material part 19. The bottom part 20 of the crucible is molded using a highly castable alumina-based material. The cooling part 18 of the crucible is molded using coil cement in which a water cooling tube is buried and kept at a low temperature during the purification process. The coating material part 19 of the crucible is made of integrally molded alumina brick since this part of the crucible directly contacts the oxidizing agent and is corrosion resistant. Then, 2 kg of powdered sodium carbonate (Na₂CO₃) having a boron concentration of 0.3 mass ppm and a temperature of room temperature is fed onto the molten silicon in the purification furnace through an oxidizing agent feeding tube 7. The surface of the oxidizing agent is flattened so that the depth of the oxidizing agent on the molten silicon is uniform. The silicon purification process is carried out for 20 minutes while maintaining the molten silicon at 1500° C. under argon atmospheric pressure. During the purification, the sodium carbonate is heated from the molten silicon and at the same time is cooled from the cooling part of the crucible via the coating material part. As a result, there is no explosive vaporization of sodium carbonate observed. This seems to be because the sodium carbonate is heated beyond the vaporization temperature only in a limited small area adjacent to the molten silicon. Temperature distribution in the oxidizing agent is measured using a sheathed thermocouple and the average temperature during the purification process is about 700° C. After finishing the purification, the residue on the molten silicon is removed in a same manner as in Example 4, using the removal device 17. Then, the molten silicon is sampled. The sampling and the analysis are made in the same manner as in Example 1. Then, oxidizing agent is again fed onto the molten silicon to repeat the purification. A total of five purifications are carried out. Sampling is made at every purification by using the oxidizing agent removal device and the boron concentration in each sample shows ⅓ of the concentration of the previous sample from first to fourth purification. The boron concentration of the finally obtained sample is 0.1 mass ppm, which satisfies the boron concentration requirements of silicon intended for solar batteries.

All cited patents, publications, copending applications, and provisional applications referred to in this application are herein incorporated by reference.

The invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for producing high purity silicon by removing boron from silicon by oxidization thereof, comprising:
commencing an oxidization reaction between an oxidizing agent and molten silicon, and
cooling at least a part of the oxidizing agent during the oxidation reaction.

2. The method according to claim 1, wherein the oxidizing agent is placed so as to directly contact the molten silicon.

3. The method according to claim 2, further comprising:
blowing a cooling gas onto the oxidizing agent.

4. The method according to claim 2, further comprising:
placing a cooling material on the oxidizing agent, wherein said cooling material has a temperature lower than that of the molten silicon.

5. The method according to claim 4, further comprising:
blowing a cooling gas onto the oxidizing agent and/or cooling material.

6. The method according to claim 5, wherein the cooling material comprises as a primary component at least one material selected from the group consisting of: silica, alumina, magnesia, zirconia and calcia.

7. The method according to claim 1, wherein said cooling is conducted by placing a cooling material on the oxidizing agent, wherein said cooling material has a temperature lower than that of the molten silicon.

8. The method according to claim 7, wherein the cooling material comprises as a primary component at least one material selected from the group consisting of: silica, alumina, magnesia, zirconia and calcia.

9. The method according to claim 7, further comprising:
blowing a cooling gas onto the oxidizing agent and/or cooling material.

10. The method according to claim 1, wherein said cooling is conducted by blowing a cooling gas on at least a part of said oxidizing agent, wherein said cooling gas has a temperature lower than that of the oxidizing agent.

11. A method for producing high purity silicon by removing boron from silicon by oxidization thereof, comprising:
placing an insulation material on molten silicon,
placing an oxidizing agent on the insulation material, and
commencing an oxidization reaction between the oxidizing agent and the molten silicon.

12. The method according to claim 11, further comprising:
blowing a cooling gas onto the oxidizing agent and/or the insulation material.

13. The method according to claim 11, wherein the insulation material comprises a porous material having an average temperature lower than that of the molten silicon, and wherein said oxidizing agent is arranged over the porous material and/or inside the porous material so that temperature increase of the oxidizing agent can be restrained.

14. The method according to claim 1, wherein the oxidizing agent is a material comprising as a primary component at least one material selected from the group consisting of: alkali metal carbonate, hydrate of alkali metal carbonate, alkali metal hydroxide, alkaline-earth metal carbonate, hydrate of alkaline-earth metal carbonate and alkaline-earth metal hydroxide.

15. The method according to claim 11, wherein the oxidizing agent is a material comprising as a primary component at least one material selected from the group consisting of: alkali metal carbonate, hydrate of alkali metal carbonate, alkali metal hydroxide, alkaline-earth metal carbonate, hydrate of alkaline-earth metal carbonate and alkaline-earth metal hydroxide.

16. The method according to claim 1, wherein the oxidizing agent is a material comprising as a primary component at least one material selected from the group consisting of: sodium carbonate, potassium carbonate, sodium hydrogen carbonate, potassium hydrogen carbonate, magnesium carbonate, calcium carbonate, hydrates of each of the above carbonates, magnesium hydrate and calcium hydrate.

17. The method according to claim 11, wherein the oxidizing agent is a material comprising as a primary component at least one material selected from the group consisting of: sodium carbonate, potassium carbonate, sodium hydrogen carbonate, potassium hydrogen carbonate, magnesium carbonate, calcium carbonate, hydrates of each of the above carbonates, magnesium hydrate and calcium hydrate.
